(19) United States
(12) Patent Application Publication
(10) Pub. No.: US 2010/0323886 A1
(43) Pub. Date: Dec. 23, 2010

(54) Composition and Methods for Seed Treatment Use

(75) Inventors: Dirk Voeste, Limburgerhof (DE); Egon Haden, Ludwigshafen (DE); Markus Gewehr, Kastellaun (DE)

Correspondence Address: BRINKS, HOFER, GILSON & LIONE, P.O. BOX 110285, RESEARCH TRIANGLE PARK, NC, 27709, US

(73) Assignee: BASF SE, Ludwigshafen (DE)

(21) Appl. No.: 12/865,608

(22) PCT Filed: Feb. 3, 2009
(86) PCT No.: PCT/EP2009/051167

§ 371 Date: Jul. 30, 2010

(30) Foreign Application Priority Data
Feb. 4, 2008 (EP) 08101247.8

(51) Int. Cl. A01C 1/06; A01N 47/12; A01P 3/00; A01P 13/00

(52) U.S. Cl. 504/100; 504/248; 504/345

(57) ABSTRACT

The present invention relates to methods for controlling phytopathogenic fungi and/or improving the health of a plant, in particular by seed treatment using a combination of pyraclostrobin and a plant growth regulator.

The present invention relates to methods for controlling phytopathogenic fungi and/or improving the health of a plant, in particular by seed treatment using a combination of pyraclostrobin and a plant growth regulator.

One typical problem arising in the field of pest control lies in the need to reduce the dosage rates of the active ingredient in order to reduce or avoid unfavorable environmental or toxicological effects whilst still allowing effective pest control.

Another difficulty in crop protection is that the repeated and exclusive application of an individual pesticidal compound leads in many cases to a rapid selection of phytopathogenic fungi, which have developed natural or adapted resistance against the active compound in question.

Another problem underlying the present invention is the desire for compositions that improve the health of plants. Healthier plants are desirable since they result in better yields of the fruits of the plant and/or a better quality of the plants or fruits. This further offers the possibilty to reduce the amounts of active compounds needed in agriculture and helps avoiding the development of resistances against the respective pesticides.

WO 2007/001919 A1 is directed to mixtures of strobilurin fungicides and plant growth regulators and to the application of these mixtures to crops, in particular to cotton by foliar application.

It was an object of the present invention to provide agricultural methods and compositions, which result in a good efficiency against harmful fungi and solve the problems of reducing the dosage rate and/or enhancing the spectrum of activity and/or to resistance management. Furthermore, it was an object of the present invention to provide compositions and methods that result in an improvement of the health of a plant.

Surprisingly, the problems explained above are in part or in whole solved by the combination of active compounds and/or methods as defined herein.

Accordingly, one aspect of the present invention is a method for controlling phytopathogenic fungi in and/or on a plant and/or improving the health of a plant, wherein the seeds, from which the plant is expected to grow, before sowing and/or after pregermination, are treated with pyraclostrobin and a PGR in synergistically effective amounts.

According to one embodiment, the method is for controlling phytopathogenic fungi.

According to a further embodiment, the method is for improving the health of a plant.

A further aspect of the present invention relates to a method for the protection of seed comprising contacting the seed before sowing and/or after pregermination with pyraclostrobin and a plant growth regulator in synergistically effective amounts.

In this context, the protection of seed means in particular, that the seed or propagation material is protected from fungal attack before sowing and/or after pregermination. Thus, one purpose of this seed treatment is to control phytopathogens. The treatment protects the seed during storage and sowing and up to germination. However, a further aspect is that also the plants that are growing from seed that has been treated with said combination of pyraclostrobin and a PGR can be protected. The protection can be effective during germination and thereafter, preferably for longer than the emergence phase, particularly preferably for at least eight weeks after sowing and again particularly preferably for at least four weeks after sowing. According to the present invention, the seed treatment thus involves a fungicidal effect or a fungicidal activity providing protection against damage done by said fungi to a seed and/or a plant grown from the seed.

According to a further embodiment of the invention, by means of seed treatment also the health of the plants that are growing from seed that has been treated with said combination of pyraclostrobin and a PGR can be improved.

The present invention also comprises seeds coated with or containing pyraclostrobin and a PGR. Thus, a further aspect of the present invention relates to seed comprising pyraclostrobin and a PGR, wherein pyraclostrobin and the PGR are present in synergistically effective amounts, and wherein each of the actives is usually present in an amount of 0.1 to 1000 g per 100 kg seed, in particular 1 to 1000 g per 100 kg seed.

Still a further aspect of the present invention is a method for the production of seed comprising pyraclostrobin and a PGR, wherein pyraclostrobin and the PGR are present in synergistically effective amounts, and wherein each of the actives is usually present in an amount of 0.1 to 1000 g per 100 kg seed, in particular 1 to 1000 g per 100 kg seed.

In still a further aspect, the present invention relates to a composition comprising, as active components, pyraclostrobin and chlormequat chloride.

In a further embodiment, the present invention relates to the use of a composition comprising, as active components, pyraclostrobin and chlormequat chloride, for the improvement of the health of a plant.

Especially, it has been found that a composition of pyraclostrobin and chlormequat chloride is suitable for improving the health of plants when applied to plants, parts of plants, seeds, or at their locus of growth, wherein the improvement is surprisingly higher compared to the control rates that are possible with the individual compounds (synergism). Thereby, it has been found that the mixture of pyraclostrobin and chlormequat chloride is exceptionally suitable for seed treatment for improving the health of said plant.

In a further embodiment, the present invention relates to the use of a composition comprising, as active components, pyraclostrobin and chlormequat chloride for the control of phytopathogenic fungi. Especially, it has been found that a composition of pyraclostrobin and chlormequat chloride achieves markedly enhanced action against plant pathogens (phytopathogenic fungi) compared to the control rates that are possible with the individual compounds when applied to plants, parts of plants, seeds, or at their locus of growth (synergism). In particular, it has been found that the mixture of pyraclostrobin and chlormequat chloride is exceptionally suitable for seed treatment for protecting crops from phytopathogenic fungi.

Pyraclostrobin and chlormequat chloride can be applied jointly or separately. In the case of separate application, the application of the individual active ingredients can be simultaneously or—as part of a treatment sequence—one after the other, where the application in the case of successive application is preferably carried out at an interval of from a few minutes to a number of days. Thus, the present invention also relates to agents which include both 1) compositions comprising (a) pyraclostrobin and (b) chlormequat chloride, as well as 2) kits comprising a first component which comprises pyraclostrobin and a second component which comprises chlormequat chloride, where the first and the second component are generally present in the form of separate compositions.

Pyraclostrobin is a fungicide. See, for example, the Pesticide Manual, 13th Ed. (2003), The British Crop Protection Council, London, page 842. See also EP 0 804 421 B1.

Plant growth regulators (PGRs) are a group of substances that alter general and specific growth and differentiation and development processes in a plant. In particular, PGRs generally accelerate or retard the rate of growth or maturation of plants or their produce. For example, some PGRs can stimulate seed germination, alter the plant height or change the rate of plant growth, induce flowering, darken leaf coloring, or modify the timing and efficiency of fruiting. PGRs can be subdivided into several subcategories, including:

Antiauxins such as clofibric acid and 2,3,5-tri-iodobenzoic acid;
Auxins, such as 2,4-dichlorophenoxy acetic acid (2,4-D), 4-(2,4-dichlorophenoxy)butyric acid (2,4-DB), dichlorprop, fenoprop, naphthalene acetamide, α-naphthalene acetic acid, 1-naphthole, naphthoxy acetic acid, potassium naphthenate, sodium naphthenate, (2,4,5-trichlorophenoxy)acetic acid (2,4,5-T);
Gibberellines, such as gibberellinic acid;
Cytokinins, such as benzyladenine, kinetin, zeatin;
Defoliants, such as calcium cyanamide, dimethipin, endothal, ethephon, merphos, metoxuron, pentachlorophenol, thidiazuron, tribufos;
Ethylene inhibitors, such as aviglycine, 1-methylcyclopropene;
Ethylene releasers, such as ACC, etacelasil, ethephon, glyoxime;
Growth inhibitors, such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat and salts thereof, piproctanyl, prohydrojasmon, propham, 2,3,5-tri-iodobenzoic acid;
Morphactins, such as chlorfluren, chlorflurenol, dichlorflurenol, flurenol;
Growth retardants and growth modifiers, such as chlormequat chloride, daminozide, flurprimidol, mefluidide, paclobutrazole, cyproconazole, tetcyclacis, uniconazole;

Growth stimulators, such as brassinolide, forchlorfenuron, hymexazol, 2-amino-6-oxypurine derivatives, indolinone derivatives, 3,4-disubstituted maleimide derivatives and fused azepinone derivatives.

In particular suitable according to the present invention are ethylene inhibitors, growth inhibitors, growth retardants and growth modifiers.

Specific examples for suitable growth inhibitors are mepiquat and mepiquat salts, especially mepiquat and mepiquat pentaborate.

A specifically suitable example for growth retardants is chlormequat chloride.

Consequently, in the methods of the present invention, preferably pyraclostrobin is used together with a PGR selected from mepiquat, mepiquat pentaborate and chlormequat chloride in synergistically effective amounts

As used herein, the terms “fungicidal effect” and “fungicidal activity” mean any direct or indirect action on the target fungus that results in reduction of damage on the treated seeds as well as on the plants or their parts (fruits, roots, shoots and/or foliage) grown from treated seeds as compared to untreated seeds or to plants grown from untreated seeds, respectively. Such direct or indirect actions include killing the fungus, and inhibiting or preventing reproduction of the fungus.

“Improving the health of a plant” as used herein is meant to be improved crop characteristics including: emergence, crop yields, protein content, more developed root system, tillering increase, increase in plant height, bigger leaf blade, less dead basal leaves, stronger tillers, greener leaf color, pigment content, photosynthetic activity, less fertilizers needed, less seeds needed, more productive tillers, earlier flowering, early grain maturity, less plant verse (lodging), increased shoot growth, improved water stress tolerance, improved plant vigor, increased plant stand and early germination; or any other advantages familiar to a person skilled in the art.

According to the present invention, “increased yield” of an agricultural plant means that the yield of a product of the respective plant is increased by a measurable amount over the yield of the same product of the plant produced under the same conditions, but without the application of the present invention. According to the present invention, it is preferred that the yield be increased by at least 0.5%, more preferred at least 1%, even more preferred at least 2%, still more preferred at least 4%.

According to the present invention, “improved plant vigor” means that certain crop characteristics are increased or improved by a measurable or noticeable amount over the same factor of the plant produced under the same conditions, but without the application of the present invention, such as: delay of senescence, root growth, longer panicles, increased or improved plant stand, the plant weight, plant height, emergence, improved visual appearance, improved protein content, more developed root system, tillering increase, increase in plant height, bigger leaf blade, less dead basal leaves, stronger tillers, greener leaf color, pigment content, photosynthetic activity, less fertilizers needed, less seeds needed, more productive tillers, earlier flowering, early grain maturity, less plant verse (lodging), increased shoot growth, early and improved germination, improved vitality of the plant, improved quality of the plant, improved quality of the fruits or vegetables (or other products produced by the plant), improved self defense mechanism of the plant such as induced tolerance against fungi, bacteria, viruses and/or insects.

The improvement of the plant vigor according to the present invention particularly means that the improvement of any one or several or all of the above mentioned plant characteristics are improved independently of the pesticidal action of the composition or active ingredients.

According to one embodiment of the present invention, the yield of an agricultural plant is increased.

According to a further embodiment of the present invention, the inventive composition or methods are used for stimulating the natural defensive reactions of a plant against a pathogen and/or a pest. Thereby, the plant can be protected against unwanted microorganisms such as phytopathogenic fungi, bacteria, viruses and insects and it has been found that the inventive compositions result in plant strengthening effects. Therefore, they are useful for mobilizing the plant's defense mechanisms against the attack of unwanted microorganisms. Consequently, the plant becomes tolerant or resistant towards these microorganisms. Unwanted microorganisms in this context are phytopathogenic fungi and/or bacteria and/or viruses and/or insects, preferably phytopathogenic fungi, bacteria and/or viruses, wherein, according to the present invention, the treated plant may develop increased defense mechanism against one of these pathogens/pests or against two, three or all of these pathogens/pests.

According to a further embodiment of the present invention, the water stress tolerance of the plant is improved. One of the commonest environmental stress factors that limits the plant productivity is water deficit. “Water stress tolerance” in this context means the ability of a plant to have improved abilities to tolerate water deficit.

According to a further embodiment of the present invention, the germination of the agricultural plant is improved.

Surprisingly, the combination of pyraclostrobin and PGR as used in the inventive methods has a better activity than would have been expected based on the activity of the individual compounds, i.e. the fungicidal activity and/or the improvement of the health of the plant is increased in a superadditive manner. This means that, by using the combination, an enhanced activity against harmful fungi and/or improved plant health in the sense of a synergetic effect (synergism) is achieved. For this reason, the combinations may be employed at lower total application rates.

In the methods and combination of the invention, pyraclostrobin and the PGR are present in synergistically effective amounts. In particular the combination comprises pyraclostrobin and a PGR (in particular chlormequat chloride) in a weight ratio of usually from 200:1 to 1:200, more preferably from 100:1 to 1:100, particularly preferably from 50:1 to 1:50 and especially from 10:1 to 1:10. For example, ratios of 2.5 g:1 g a.i./100 kg or 1 g:2.5 g a.i./100 kg of seed are suitable.

Pyraclostrobin and the PGR can be applied jointly or separately. In the case of separate application, the application of the individual active ingredients can be simultaneously or—as part of a treatment sequence—one after the other, where the application in the case of successive application is preferably carried out at an interval of from a few minutes to a number of days.

The seed treatment application of the compositions of the invention is carried out by spraying or dusting the seeds before sowing of the plants and before emergence of the plants.

In the treatment of seeds the corresponding formulations are commonly applied by treating the seeds with an effective amount of the compositions of the invention. Herein, the application rates of the compositions of the invention are generally from 0.1 to 10 kg per 100 kg seed, preferably from 1 g to 5 kg per 100 kg of seed, in particular from 1 g to 2.5 kg per 100 kg of seed. It is usually preferred that the application rates are 0.1 to 1000 g per 100 kg seed, more specifically 1 to 1000 g per 100 kg seed, still more specifically 5 to 200 g per 100 kg seed. For specific crops such as lettuce the rate can be higher.

The inventive composition and the compositions used according to the present invention can be converted into customary formulations, for example solutions, emulsions, suspensions, dusts, powders, pastes and granules. The use form depends on the particular intended purpose; in each case, it should ensure a fine and even distribution of the compound according to the invention.

Thus, any one of the compositions according to the present invention preferably contains at least one liquid or solid carrier that is agronomically suitable.

The formulations are prepared in a known manner (see e.g. for review U.S. Pat. No. 3,060,084, EP-A 707 445 (for liquid concentrates), Browning, “Agglomeration”, Chemical Engineering. Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science. John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, anti-foaming agents, anti-freezing agents, wherein colorants and/or binders and/or gelling agents may be optionally present.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example Dichlorophen and enzylalkoholhemiformal.

Seed treatment formulations may additionally comprise binders and optionally colorants.

Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like cellulose, modified cellulose, tylose and starch, polyolefin homo- and copolymers like olefin/maleic anhydride copolymers, polyurethanes, polyesters, polystyrene homo and copolymers.

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a gelling agent is carrageen (Satiagel®)

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. In this case, the active compounds are employed in a purity of from 90% to 100% by weight, preferably 95% to 100% by weight (according to NMR spectrum).

For the seed treatment purposes of the present invention, respective formulations can be diluted 2-10 fold leading to concentrations in the ready to use preparations of 0.01 to 60% by weight active compound by weight, preferably 0.1 to 40% by weight.

The inventive mixtures can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations: 1. Products for dilution with water for foliar applications. For seed treatment purposes, such products may be applied to the seed diluted or undiluted.

### A) Water-Soluble Concentrates (SL, LS)

10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.

### B) Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion, whereby a formulation with 20% (w/w) of active compounds is obtained.

### C) Emulsifiable Concentrates (EC)

15 parts by weight of the active compound(s) are dissolved in 7 parts by weight of an organic solvent, for example an alkylaromatic solvent with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO, ES)

25 parts by weight of the active compound(s) are dissolved in 35 parts by weight of an organic solvent, for example an alkylaromatic solvent with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-Dispersible Granules and Water-Soluble Granules (WG, SG) 50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP, SS, WS)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

### Gel-Formulation (GF) for Seed Treatment Purposes

In an agitated ball mill, 20 parts by weight of the active compound(s) are comminuted with addition of 10 parts by weight of dispersants, 1 part by weight of a gelling agent wetters and 70 parts by weight of water or of an organic solvent to give a fine active compound(s) suspension. Dilution with water gives a stable suspension of the active compound(s), whereby a formulation with 20% (w/w) of active compound(s) is obtained.

2. Products to be applied undiluted for foliar applications. For seed treatment purposes, such products may be applied to the seed diluted.

### I) Dustable Powders (DP, DS)

5 parts by weight of the active compound(s) are ground finely and mixed intimately with 95 parts by weight of finely divided kaolin. This gives a dustable product having 5% (w/w) of active compound(s)

### J) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulation can be applied to the seed diluted or undiluted. Application to the seeds is carried out before sowing, either directly on the seeds.

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

In accordance with one variant of the present invention, a further object of the invention is a method of treating soil by the application, in particular into the seed drill: either of a granular formulation containing the actives of the composition in combination or as a composition/formulation, or of a mixture of two granular formulations, each containing one of the two active ingredients, with optionally one or more solid or liquid, agriculturally acceptable carriers and/or optionally with one or more agriculturally acceptable surfactants. This method is advantageously employed in seedbeds of cereal, maize, cotton and sunflower. For cereals and maize, the rates for pyraclostrobin are between 50 and 500 g/ha and those of the PGR are between 50 and 200 g/ha.

As used herein, the term “plant” means an entire plant or parts thereof. The term “entire plant” refers to a complete plant individual in its vegetative, i.e. non-seed stage, characterized by the presence of an arrangement of roots, shoots and foliage, depending on the developmental stage of the plant also flowers and/or fruits, all of which are physically connected to form an individual which is, under reasonable conditions, viable without the need for artificial measures. The term may also refer to an entire plant harvested as such.

The term “plant parts” refers to roots, shoots, foliage, flowers or other parts of the vegetative stage of the plant, which, when dislodged and disconnected from the rest, are incapable of survival, unless supported by artificial measures or able to re-grow the missing parts to form an entire plant. As used herein, fruits are also considered as plant parts.

The term “seed” embraces seeds and plant propagules of all kinds including but not limited to true seeds, seed pieces, suckers, corms, bulbs, fruit, tubers, grains, cuttings, cut shoots and the like and means in a preferred embodiment true seeds.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be mentioned. These young plants may also be protected before transplantation by a total or partial treatment by immersion or pouring.

The term seed treatment comprises all suitable seed treatment techniques known in the art, such as seed dressing, seed coating, seed dusting, seed soaking and seed pelleting.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens. Also suitable is seed of cotton, soybean, bajra and groundnut.

According to an embodiment of the described methods of the invention, the treatment is made to seed of corn, cotton, soybean, bajra or groundnut, in particular corn, cotton, soybean, bajra or groundnut, more specifically corn, soybean, bajra or groundnut.

In addition, the compositions of the invention may also be used for the treatment of seeds from cultivated plants.

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529. WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as 6-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374 753, WO 93/007278. WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the CrylAc toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®. Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation. Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Preferred cultivated plants are those, which tolerate the action of herbicides or fungicides or insecticides owing to breeding, including genetic engineering methods.?

The inventive composition of pyraclostrobin and chlormequat chloride is effective against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. Moreover, they are suitable for controlling harmful fungi, which inter alia occur in wood or roots of plants.

The composition of the invention is particularly important in the control of a multitude of phytopathogenic fungi on various cultivated plants, such as cereals, for example wheat, rye, barley, triticale, oats or rice; beet, for example sugar beet or fodder beet; fruits, such as pomes, stone fruits or soft fruits, for example apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, for example conifers; and on the plant propagation material, such as seeds, and the crop material of these plants.

Preferably, the composition of the invention is used for controlling a multitude of fungi on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The methods and composition according to the present invention are particularly suitable for controlling the following plant diseases:
Albugo spp. (white rust) on ornamentals, vegetables (e.g. A. candida) and sunflowers (e.g. A. tragopogonis),
Alternaria spp. (Alternaria leaf spot) on vegetables, rape (A. brassicola or brassicae), sugar beets (A. tenuis), fruits, rice, soybeans, potatoes (e.g. A. solani or A. alternata), tomatoes (e.g. A. solani or A. alternate) and wheat,
Aphanomyces spp. on sugar beets and vegetables,
Ascochyta species on cereals and vegetables, e.g. A. tritici (anthracnose) on wheat and A. hordei on barley
Bipolaris and Drechslera spp. (teleomorph: Cochliobolus spp.) on corn (e.g. D. maydis), cereals (e.g. B. sorokiniana: spot blotch), rice (e.g. B. oryzae) and turfs,
Blumeria (formerly Erysiphe) graminis (powdery mildew) on cereals (e.g. on wheat or barley),
Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat,
Bremia lactucae (downy mildew) on lettuce,
Ceratocystis (syn. Ophiostoma) spp. (rot or wilt) on broad-leaved trees and evergreens, e.g. C. ulmi (Dutch elm disease) on elms,
Cercospora spp. (Cercospora leaf spots) on corn, rice, sugar beets (e.g. C. beticola), sugar cane, vegetables, coffee, soybeans (e.g. C. sojina or C. kikuchii) and rice,
Cladosporium spp. on tomatoes (e.g. C. fulvum: leaf mold) and cereals, e.g. C. herbarum (black ear) on wheat,
Claviceps purpurea (ergot) on cereals,
Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae),
Colletotrichum (teleomorph: Glomerella) spp. (anthracnose) on cotton (e.g. C. gossypii), corn (e.g. C. graminicola), soft fruits, potatoes (e.g. C. coccodes: black dot), beans (e.g. C. lindemuthianum) and soybeans (e.g. C. truncatum),
Corticium spp., e.g. C. sasakii (sheath blight) on rice,
Corynespora cassiicola (leaf spots) on soybeans and ornamentals,
Cycloconium spp., e.g. C. oleaginum on olive trees,
Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals,
Dematophora (teleomorph: Rosellinia) necatrix (root and stem rot) on soybeans,
Diaporthe spp., e.g. D. phaseolorum (damping off) on soybeans,
Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf,
Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa,
Elsinoe spp. on pome fruits (E. pyri), soft fruits (E. veneta: anthracnose) and vines (E. ampelina: anthracnose),
Entyloma oryzae (leaf smut) on rice,
Epicoccum spp. (black mold) on wheat,
Erysiphe spp. (powdery mildew) on sugar beets (E. betae), vegetables (e.g. E. pisi), such as cucurbits (e.g. E. cichoracearum), cabbages, rape (e.g. E. cruciferarum),
Eutypa lata (Eutypa canker or dieback, anamorph: Cytosporina lata, syn. Libertella blepharis) on fruit trees, vines and ornamental woods,
Exserohilum (syn. Helminthosporium) spp. on corn (e.g. E. turcicum),
Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticillioides on corn,
Gaeumannomyces graminis (take-all) on cereals (e.g. wheat or barley) and corn,
Gibberella spp. on cereals (e.g. G. zeae) and rice (e.g. G. fujikuroi: Bakanae disease),
Glomerella cingulata on vines, pome fruits and other plants and G. gossypii on cotton,
Grainstaining complex on rice,
Guignardia bidwellii (black rot) on vines,
Gymnosporangium spp. on rosaceous plants and junipers, e.g. G. sabinae (rust) on pears,
Helminthosporium spp. (syn. Drechslera, teleomorph: Cochliobolus) on corn, cereals and rice,
Hemileia spp., e.g. Hemileia vastatrix (coffee leaf rust) on coffee,
Isariopsis clavispora (syn. Cladosporium vitis) on vines,
Macrophomina phaseolina (syn. phaseoli) (root and stem rot) on soybeans and cotton,
Microdochium (syn. Fusarium) nivale (pink snow mold) on cereals (e.g. wheat or barley),
Microsphaera diffusa (powdery mildew) on soybeans,
Monilinia spp., e.g. M. laxa, M. fructicola and M. fructigena (bloom and twig blight, brown rot) on stone fruits and other rosaceous plants,
Mycosphaerella spp. on cereals, bananas, soft fruits and ground nuts, such as e.g.
M. graminicola (anamorph: Septoria tritici. Septoria blotch) on wheat or M. fijiensis (black Sigatoka disease) on bananas,
Peronospora spp. (downy mildew) on cabbage (e.g. P. brassicae), rape (e.g. P. parasitica), onions (e.g. P. destructor), tobacco (P. tabacina) and soybeans (e.g. P. manshurica),
Phakopsora pachyrhizi and P. meibomiae (soybean rust) on soybeans,
Phialophora spp. e.g. on vines (e.g. P. tracheiphila and P. tetraspora) and soybeans (e.g. P. gregata: stem rot),
Phoma lingam (root and stem rot) on rape and cabbage and P. betae (root rot, leaf spot and damping-off) on sugar beets,
Phomopsis spp. on sunflowers, vines (e.g. P. viticola: can and leaf spot) and soybeans (e.g. stem rot: P. phaseoli, teleomorph: Diaporthe phaseolorum),
Physorma maydis (brown spots) on corn,
Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans: late blight) and broad-leaved trees (e.g. P. ramorum: sudden oak death)
Plasmodiophora brassicae (club root) on cabbage, rape, radish and other plants,
Plasmopara spp., e.g. P. viticola (grapevine downy mildew) on vines and P. halstedii on sunflowers,
Podosphaera spp. (powdery mildew) on rosaceous plants, hop, pome and soft fruits, e.g. P. leucotricha on apples,
Polymyxa spp., e.g. on cereals, such as barley and wheat (P. graminis) and sugar beets (P. betae) and thereby transmitted viral diseases,
Pseudocercosporella herpotrichoides (eyespot, teleomorph: Tapesia yallundae) on cereals, e.g. wheat or barley,
Pseudoperonospora (downy mildew) on various plants, e.g. P. cubensis on cucurbits or P. humili on hop,
Pseudopezicula tracheiphila (red fire disease or, rotbrenner', anamorph: Phialophora) on vines,
Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, and asparagus (e.g. P. asparagi),
Pyrenophora (anamorph: Drechslera) tritici-repentis (tan spot) on wheat or P. teres (net blotch) on barley,
Pyricularia spp., e.g. P. oryzae (teleomorph: Magnaporthe grisea, rice blast) on rice and P. grisea on turf and cereals,
Pythium spp. (damping-off) on turf, rice, corn, wheat, cotton, rape, sunflowers, sugar beets, vegetables and various other plants (e.g. P. ultimum or P. aphanidermatum),
Ramularia spp., e.g. R. collo-cygni (Ramularia leaf spots, Physiological leaf spots) on barley and R. beticola on sugar beets,
Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley,
Rhizopus stolonifer (black mold, soft rot) on strawberries, carrots, cabbage, vines and tomatoes,
Rhynchosporium secalis (scald) on barley, rye and triticale,
Sarocladium oryzae and S. attenuatum (sheath rot) on rice,
Sclerotinia spp. (stem rot or white mold) on vegetables and field crops, such as rape, sunflowers (e.g. S. sclerotiorum) and soybeans (e.g. S. rolfsii),
Septoria spp. on various plants, e.g. S. glycines (brown spot) on soybeans, S. tritici (Septoria blotch) on wheat and S. (syn. Stagonospora) nodorum (Stagonospora blotch) on cereals,
Uncinula (syn. Erysiphe) necator (powdery mildew, anamorph: Oidium tuckeri) on vines,
Setospaeria spp. (leaf blight) on corn (e.g. S. turcicum, syn. Helminthosporium turcicum) and turf,
Sphacelotheca spp. (smut) on corn, (e.g. S. reiliana: head smut), sorghum und sugar cane,
Sphaerotheca fuliginea (powdery mildew) on cucurbits,
Spongospora subterranea (powdery scab) on potatoes and thereby transmitted viral diseases,
Stagonospora spp. on cereals, e.g. S. nodorum (Stagonospora blotch, teleomorph: Leptosphaeria [syn. Phaeosphaeria] nodorum) on wheat,
Synchytrium endobioticum on potatoes (potato wart disease),
Taphrina spp., e.g. T. deformans (leaf curl disease) on peaches and T. pruni (plum pocket) on plums,
Thielaviopsis spp. (black root rot) on tobacco, pome fruits, vegetables, soybeans and cotton, e.g. T. basicola (syn. Chalara elegans),
Tilletia spp. (common bunt or stinking smut) on cereals, such as e.g. T. tritici (syn. T. caries, wheat bunt) and T. controversa (dwarf bunt) on wheat,
Typhula incarnata (grey snow mold) on barley or wheat,
Urocystis spp., e.g. U. occulta (stem smut) on rye,
Uromyces spp. (rust) on vegetables, such as beans (e.g. U. appendiculatus, syn. U. phaseoli) and sugar beets (e.g. U. betae),
Ustilago spp. (loose smut) on cereals (e.g. U. nuda und U. avaenae), corn (e.g. U. maydis: corn smut) and sugar cane,
Venturia spp. (scab) on apples (e.g. V. inaequalis) and pears,
Verticillium spp. (wilt) on various plants, such as fruits and ornamentals, vines, soft fruits, vegetables and field crops, e.g. V. dahliae on strawberries, rape, potatoes and tomatoes.

According to the invention the compositions of pyraclostrobin and PGR (in particular chlormequat chloride) can also be present together with other active compounds, e.g. with herbicides, insecticides, growth regulators, fungicides or else with fertilizers.

The advantageous effectivity of the methods and composition of the present invention are demonstrated by the following experiments:

### EXAMPLES

### Example 1

Seed of wheat was treated in a batch treater as standard equipment. The intensity of mixing was steered by selecting adequate mixing duration. The relevant volume of slurry was taken up from the mixing vessel with a pipette and applied through an opening into the center of the treater. The treater was started and applied the chemical slowly to obtain maximum distribution on the seed. After completion of mixing time the treater was stopped and the treated seed was filled in paper bags, allowing for aeration and drying of the seed. The compounds were applied with the below indicated application rate(s) per kg seed. The slurry preparation had to be adjusted to include adequate surplus to cover the losses in machinery.

After been treated and dried the seeds were seeded in common quantities with regular agricultural equipment into the prepared field. The trial design selected was a randomized bloc-design embracing 3 repetitions of each treatment.

The number of died plants were determined 71 days after seeding.

The results are shown below:

### Crop: Wheat

| | | Number of |
|---|---|---|
| | | plants died/Plot - |
| | g ai/kg of | 71 Days after |
| Treatment | seed | Seeding |
| untreated | | 56 |
| Chlormequat chloride 50% SL | 2 | 16 |
| pyraclostrobin 20% WG | 0.2 | 50 |
| Chlormequat chloride 50% + | 0.2 + 2 | 13 |
| pyraclostrobin 5% FS | | |

### Example 2

Seed of corn was treated in a batch treater as standard equipment. The intensity of mixing was steered by selecting adequate mixing duration. The relevant volume of slurry was taken up from the mixing vessel with a pipette and applied through an opening into the center of the treater. The treater was started and applied the chemical slowly to obtain maximum distribution on the seed. After completion of mixing time the treater was stopped and the treated seed was filled in paper bags, allowing for aeration and drying of the seed. The compounds were applied with the below indicated application rate(s) per kg seed. The slurry preparation had to be adjusted to include adequate surplus to cover the losses in machinery.

After having been treated and dried the seeds were seeded in common quantities with regular agricultural equipment into the prepared field. The trial design selected was a randomized bloc-design embracing 3 repetitions of each treatment.

The number of died plants were determined 65 days after seeding.

The results are shown below:

Crop: Corn (Zea mays)

| | | Number of |
|---|---|---|
| | | plants died/Plot - |
| | g ai/kg of | 65 Days after |
| Treatment | seed | Seeding |
| untreated | | 39 |
| Chlormequat chloride 50% SL | 2 | 9 |
| pyraclostrobin 20% WG | 0.2 | 30 |
| Chlormequat chloride 50% + | 0.2 + 2 | 6 |
| pyraclostrobin 5% FS | | |

1. A composition comprising, as active components, pyraclostrobin and chlormequat chloride in synergistically effective amounts.

2. The composition of claim 1, wherein pyraclostrobin and chlormequat chloride are present in a weight ratio of from 100:1 to 1:100.

3. The composition of claim 1, wherein the composition is effective to improve the health of a plant.

4. The composition of claim 1, wherein the composition is effective to control phytopathogenic fungi.

5-18. (canceled)

19. Seed, comprising pyraclostrobin and a plant growth regulator, wherein pyraclostrobin and the plant growth regulator are present in synergistically effective amounts and wherein each of pyraclostrobin and the plant growth regulator is present in an amount of 0.1 to 1000 g per 100 kg seed.

20. The seed of claim 19, wherein the plant growth regulator is selected from the group consisting of chlormequat chloride, mepiquat and a salt of mepiquat.

21. The seed of claim 20, wherein the plant growth regulator is chlormequat chloride.

22. The seed of claim 20, wherein the plant growth regulator is mepiquat pentaborate.

23. The seed of claim 19, wherein the seed is genetically modified.

24. A method for the preparation of the seed of claim 19, comprising contacting a conventionally available seed with pyraclostrobin and a plant growth regulator.

25. The method of claim 24, wherein the plant growth regulator is selected from the group consisting of chlormequat chloride, mepiquat and a salt of mepiquat.

26. The method of claim 25, wherein the plant growth regulator is chlormequat chloride.

27. The method of claim 25, wherein the plant growth regulator is mepiquat pentaborate.

28. The method of claim 24, wherein the germination of a plant grown from the seed is improved.

29. The method of claim 24, wherein the water stress tolerance of the plant is improved.

30. The method of claim 24, wherein a plant grown from the seed is tolerant towards herbicides and/or fungicides and/or insecticides owing to breeding, including genetic engineering methods.

31. A method for controlling phytopathogenic fungi in and/or on a plant and/or improving the health of a plant, wherein a seed, from which the plant is expected to grow, is treated with pyraclostrobin and a plant growth regulator in synergistically effective amounts before sowing and/or after pregermination of the seed.

32. The method of claim 31, wherein the plant growth regulator is selected from the group consisting of chlormequat chloride, mepiquat and a salt of mepiquat.

33. The method of claim 32, wherein the plant growth regulator is chlormequat chloride.

34. The method of claim 32, wherein the plant growth regulator is mepiquat pentaborate.
